(19) United States
(12) Patent Application Publication
(10) Pub. No.: US 2013/0043992 A1
(43) Pub. Date: Feb. 21, 2013

(54) Micro Handheld Alarm Network System for and Method of Alerting to Any Loss of a Network Entity

(71) Applicants: Arthur MAYER-SOMMER, Herzlia Pituach (IL); Nimrod Rospsha, Rishon Le Zion (IL)

(72) Inventors: Arthur MAYER-SOMMER, Herzlia Pituach (IL); Nimrod Rospsha, Rishon Le Zion (IL)

(21) Appl. No.: 13/570,715

(22) Filed: Aug. 9, 2012

(30) Foreign Application Priority Data
Aug. 15, 2011 (IL) 214663

(51) Int. Cl. G08B 1/08

(52) U.S. Cl. 340/539.11

(57) ABSTRACT

A micro handheld alarm network system for alerting to any lose of a network entity is presented herein. The micro handheld alarm network system contains several system elements first type which communicate between them by means of wireless communication first type protocols such as a Zigbee (IEEE 802.15.4 standard). The Zigbee standard includes a method of determining the distance between every two system elements within the micro handheld network. The micro handheld alarm network system can also include at least one system elements second type, which can, in addition, communicate by means of wireless communication second type protocols, such as Bluetooth and Wifi. By monitoring such distances, the system elements may decide if one or more of the system elements are drawn away from the other system elements, thereby alerting the user of such occurrence.

### REFERENCE TO CROSS-RELATED APPLICATION

This application claims priority from Israeli Patent Application No. 214663, filed on Aug. 15, 2011, herein incorporated by reference in its entirety.

### FIELD OF THE INVENTION

The present invention relates to micro handheld networks, more particularly, to micro handheld alarm networks.

### BACKGROUND OF THE INVENTION

People use many relatively small items in their daily lives such as keys, eye glasses, sun glasses, cellular phones, wallets, briefcases etc. With the increase use of relatively small items the risk of forgetting one or more of these items increase.

It is therefore necessary to have a way to tell a user when one or more items from a predefined set of items is drawn away from the rest of the items set.

For example, when a person takes out his wallet in order to pay at a store, he may forget the wallet at the cashier and start walking away, creating an increasing distance from the wallet and the user's briefcase, cell phone and sun glasses. In such a case, a system being able to detect this increased distance may alert the user regarding the loss of a certain item.

A monitoring and tracking system is described in U.S. Patent application. No. US 2007/0262862 of Barret et al., which is incorporated by reference for all purposes as if fully set forth herein.

Barret describes a monitoring and tracking system that provides one central unit that can monitor and track a numbered of monitored units.

A portable loss prevention system is described in U.S. Pat. No. 7,664,463 of Ben Ayed, which is incorporated by reference for all purposes as if fully set forth herein.

Ben Ayed describes a portable loss prevention system that uses the relatively high power Bluetooth radio-frequency transceiver and motion detectors to detect the movement and distance of a portable electronic device from the transceiver.

A separation alarm system is described in Great Britain patent application GB 2,467,126 to Stroud, which is incorporated by reference for all purposes as if fully set forth herein.

Stroud describes a separation alarm system that includes “a sensing alarm device carried by a responsible person” (i.e., one central device) and “multiple self-powered wireless transmitter devices”.

None of the prior art devices includes a network relationship between the monitored devices and none of the prior art devices include a bi-directional communication system between the monitored devices.

The present invention uses Zigbee transceivers which are integrated together with a microprocessor which yields a low energy single chip. The ZigBee protocol includes a mesh architecture in which the connection between several entities may pass through other entities.

None of the prior art devices include a logic algorithm which decides if there is a loss of a system element by using the direct distance calculations and the received data from other system elements. The operation of calculations and estimation occurs in all of the system elements without any dependency of the other system elements but it is transmitted to them for notification. All this will yields “Second Fault” mechanism and enhancement of the system reliability (No false alarm).

None of the prior art device includes alerting about violating the distance rule before a full RF disconnection of the network by means of calculating the distances between the system elements.

Prior art devices do not use the same hierarchy for all of the system elements.

Additionally, none of the prior art devices comprises all of the above characteristics and functions.

There is therefore a need for a micro handheld alarm network system for alerting to any loss of a network entity, which comprises a combination of all of the above characteristics and functions.

### SUMMARY OF THE INVENTION

The background art does not teach or suggest a micro handheld alarm network system for alerting to any lose of a network entity.

The present invention overcomes these deficiencies of the background art by providing a micro handheld alarm network system for alerting to any loss of a network entity including multiple system elements (SEs) each of which is equipped with a radio frequency (RF) transceiver and a microprocessor, enabling formation of a micro handheld network for alerting to any loss of a network entity.

Each SE is also equipped with several light emitting diodes (LEDs) or other small light sources for visual alerts and a speaker for audible alerts.

The RF communication may utilize the IEEE 802.15.4 (ZigBee) standard which requires relatively low power and includes a mesh architecture in which the connection between several SEs may pass throw other SEs.

Upon system startup, the various SEs communicate with the other SEs in the network to establish two way communications so that each SE is communicating with at least one other SE.

In case a SE is drawn away from the network, the SE detects a decrease in the RF communication received power and communicates that it is drawing away from the network to the other SEs via the two way communications even before the link is broken (due to excessive distance between SEs).

When a SE is drawn from the rest of the network, the SEs sounds an alert using their speaker and may optionally light up a LED in its front panel corresponding to the SE that has drawn away from the network.

The distance estimation and checks are done once in a predetermined time intervals (for example, once every second) and the distance threshold can be pre-adjusted to fit a specific distance (for example, two meters).

Such configurations of check time intervals and distance threshold ensure that no valuable items equipped with a SE be left behind the rest of the micro handheld network.

Upon powering up the different SEs, the SEs start to communicate with other SEs in their vicinity, creating a micro handheld alarm network system composed of all the SEs in the immediate vicinity.

In case a user needs to take only part of the micro handheld alarm network system (only some of the SEs in the network), when the user, along with part of the network, is moving away from the rest of the network, the normal alarms would go off for a predetermined amount of time at both parts of the network (which could be silenced by the user). Once there is no linkage between the two parts of the network, there are essentially two separate networks.

When the user returns to the vicinity of the second network, the SEs are able to communicate between the separated networks and combine into a single network.

According to the present invention there is provided a micro handheld alarm network system including: (a) at least one system element first type, wherein each of the at least one system element first type includes: (i) a system element transceiver and microprocessor unit: (ii) a system element battery operatively connected to the system element transceiver and microprocessor unit; (iii) a system element antenna operatively connected to the system element transceiver and microprocessor unit; (iv) a system element speaker operatively connected to the system element transceiver and microprocessor unit; and (v) a system element front panel having a system element front panel surface, operatively connected to the system element transceiver and microprocessor unit, wherein each of the at least one system elements are operatively connected to any of the rest of the at least two system elements by means of two-way wireless communication.

According to another feature of the present invention each of the system element transceiver and microprocessor units includes: a system element transceiver and microprocessor unit, the system element transceiver and microprocessor unit including: a microprocessor; and a transceiver first type, operatively connected to the microprocessor.

According to still another feature of the present invention the microprocessor includes: a received data block for receiving data from the transceiver; a distance estimation block for receiving data from the transceiver; and, a logic decision rules block for receiving data from the received data block and from the distance estimation block, and wherein the transceiver first type includes: a system element antenna; a receiver operatively connected to the system element antenna; and a transmitter operatively connected to the system element antenna.

According to still another feature of the present invention the transceiver first type is a system on a chip.

According to still another feature of the present invention the transceiver first type is a Zigbee transceiver.

According to still another feature of the present invention each of the system element front panels includes: (i) a light emitting diodes array, wherein the light emitting diodes array includes at least two light emitting diodes, wherein the at least two light emitting diodes are attached to the system element front panel surface.

According to still another feature of the present invention each of the system element front panel further includes: (ii) at least two icons attached to the system element front panel surface.

According to still another feature of the present invention the micro handheld alarm network system further includes: (b) at least another system element first type, operatively connected to at least one of the system element first type by means of two-way wireless communication first type.

According to still another feature of the present invention the micro handheld alarm network system further including: (b) at least one system element second type, wherein the system element second type includes: (i) a system element transceiver and microprocessor unit: (ii) a system element battery operatively connected to the system element transceiver and microprocessor unit; (iii) a system element antenna operatively connected to the system element transceiver and microprocessor unit; (iv) a system element speaker operatively connected to the system element transceiver and microprocessor unit; (v) a system element front panel having a system element front panel surface, operatively connected to the system element transceiver and microprocessor unit; and (vi) a transceiver second type operatively connected to the system element transceiver and microprocessor unit, wherein the system element second type is operatively connected to any of the rest of the at least one system element first type by means of two-way wireless communication first type.

According to still another feature of the present invention the micro handheld alarm network system further includes: (b) a mobile computing device, operatively connected to at least one of the system element first type.

According to still another feature of the present invention the system element second type is operatively connected to the mobile communication device by means of two-way wireless communication, selected from a group consisting of a means of two-way wireless communication first type and a means of two-way wireless communication second type.

According to still another feature of the present invention the mobile computing device is a mobile cellular telephone.

According to the present invention there is provided a method for alerting to a loss of any network entity including: (a) receiving communication signals from an element of a micro handheld alarm network system; (b) calculating received signal strength indication (RSSI), of the communication signals; (c) outputting received signal data and RSSI to a microprocessor; (d) storing the received data and said RSSI; (e) estimating distances from other system elements, of said micro handheld alarm network system; (f) deciding whether distance from said other system elements is within a specified distance; (g) sounding an alert and lighting LEDs if needed; and (h) sending estimated distances to said other system elements, of said micro handheld alarm network system.

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1 is a schematic illustration of a micro handheld alarm network, according to the present invention.

FIG. 2 is a schematic illustration of a micro handheld alarm network, according to the present invention.

FIG. 3 is a schematic illustration of an exemplary, illustrative embodiment of a front panel, according to the present invention.

FIG. 4a is a schematic illustration of an exemplary, embodiment of a system element first type, according to the present invention.

FIG. 4b is a schematic illustration of an exemplary, embodiment of a system element second type, according to the present invention.

FIG. 5 is a schematic block diagram of a SE transceiver and microprocessor unit, according to the present invention.

FIG. 6 is a schematic illustration of valuable items equipped with a system element, according to the present illustration.

### DETAILED DESCRIPTION OF EMBODIMENTS

The present invention is of a micro handheld alarm network system and method for alerting to any loss of a network entity.

The principles and operation of a micro handheld alarm network system for alerting to any loss of a network entity according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:
1 micro handheld alarm network system
10a system element (SE) first type
10b system element (SE) second type
11 mobile communication device (MCD)
12a two ways wireless communication first type
12b two-way wireless communication second type
20 system element front panel
20a system element front panel surface
21a key icon
21b wallet icon
21c brief case icon
21d sun glasses icon
21e pen icon
21f coin icon
21g belt icon
21h key chain icon
22 light emitting diodes (LEDs) array
22, LED (No. i)
22a key LED
22b wallet LED
22c brief case LED
22d sun glasses LED
22e pen LED
22f coin LED
22g belt LED
22h key chain LED
30 SE transceiver and microprocessor unit
32 SE battery
36 SE speaker
38 SE antenna
40a transceiver first type
40b transceiver second type
41 communication, power, and control lines
42 receiver
44 transmitter
46 received signal strength indication (RSSI) level block
48 pilot signal
50 microprocessor
52 received data block
54 distance estimation block
56 logic decision rules block
60 sun glasses
61 sun glasses arm
70 pen
71 pen cap
80 credit card sized SE

Referring now to the drawings, FIG. 1 is a schematic illustration of a micro handheld alarm network system 1, according to the present invention.

The micro handheld alarm network system 1 includes several system elements (SE) first type 10a which communicate with each other using two way wireless communications first type 12a (usually using radio frequency (RF) communication protocol such as IEEE 802.15.4 (ZigBee)).

In the present figure, each SE first type 10a is communicating with exactly two other SEs first type 10a. In this example, SE2 and SE3 do not communicate due to the great distance between them, but when there is a small enough distance between all the SEs first type 10a, each SE first type 10a may communicate with all the other SEs first type 10a as it is part of the ZigBee protocol.

Another variant of the present invention includes in addition to the SEs first type 10a, a mobile communication device (MCD) 11 such as a cellular telephone, a personal media player, or another electronic device which can communicate with the SEs first type 10a.

The MCD 11 communicates with at least one SE first type 10a in the micro handheld alarm network system 1 and is used to monitor the various features of the micro handheld alarm network system 1 such as alarming in case of loss of communication with any SE first type 10a and configuration of the micro handheld alarm network system's 1 parameters such as the alerting distance, manual addition of SEs 11 to the network, etc.

Other applications and configurations of the micro handheld alarm network system 1 can be added to the MCD's 11 capabilities as required by the network's users.

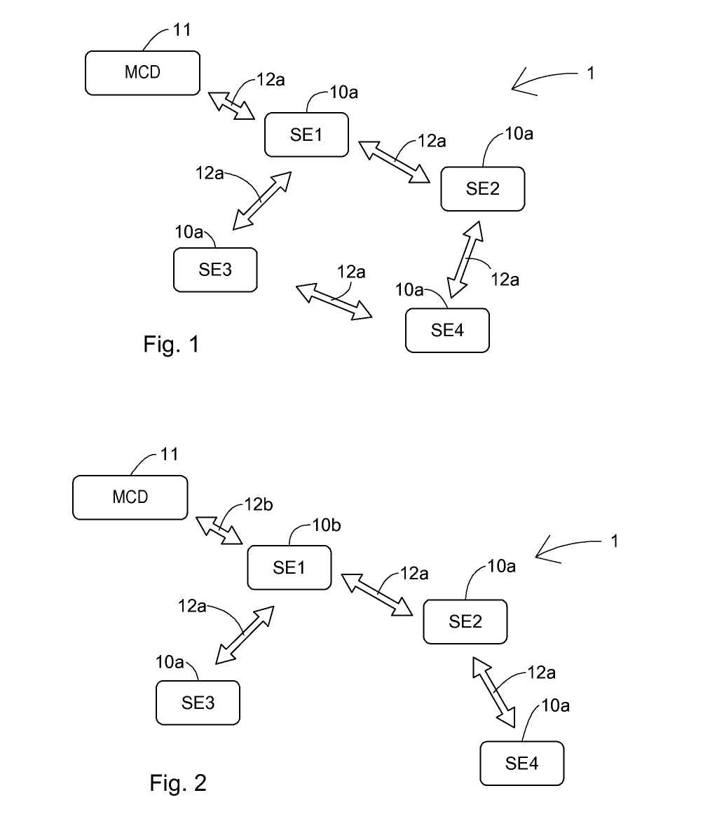

FIG. 2 is a schematic illustration of a micro handheld alarm network system 1, according to the present invention.

In the present figure, two SEs first type 10a (SE3 and SE4), are taken away from each other, but the micro handheld alarm network system 1 is still intact and no SE first type 10a is lost. Each SE first type 10a has the RSSI level of all the other SEs first type 10a in the micro handheld alarm network system 1.

Another variant of the present invention includes in addition to the SEs first type 10a, at least one SE second type 10b. The SE second type 10b can communicate with the other SEs first type 10a by the means of wireless communication first type 12a and with the MCD 11 also by means of wireless communication second type 12b protocols, such as Bluetooth and Wifi, or other communication channels.

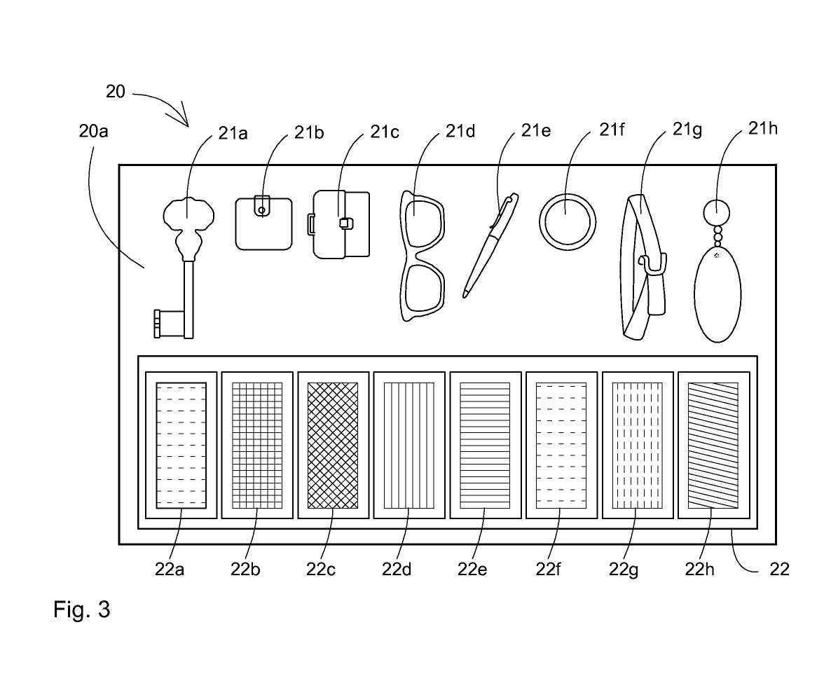

FIG. 3 is a schematic illustration of an exemplary, illustrative embodiment of a front panel 20, according to the present invention.

Each SE first type 10a (not shown in the present figure, shown in FIG. 1) is equipped with a front panel 20 which includes several icons and light emitting diodes (LEDs), on a system element front panel surface 20a. The present figure describes one exemplary front panel 20 which includes a key icon 21a, a wallet icon 21b, a brief case icon 21c, a sun glasses icon 21d, a pen icon 21e, a coin icon 21f, a belt icon 21g, and a key chain icon 21h, and a light LEDs array 22, where for each icon there is a corresponding LED; a key LED 22a, a wallet LED 22b, a brief case LED 22c, a sun glasses LED 22d, a pen LED 22e, a coin LED 22f, a belt LED 22g, and a key chain LED 22h.

Each LED may have a different color than the other LEDs in the SE first type 10a. In the present illustration, the key LED 22a is black, the wallet LED 22b is yellow, the brief case LED 22c is orange, the sun glasses LED 22d is red, the pen LED 22e is blue, the coin LED 22f is gray, the belt LED 22g is purple, and the key chain LED 22h is green.

When a certain SE first type 10a is detected to have drawn away from the other SEs first type 10a in the micro handheld alarm network system 1, the other SE first type 10a front panels 20 light up the corresponding LED to indicate that that specific SE first type 10a has drawn away.

The present figure is one exemplary embodiment of the front panel 20 and is not intended to limit the present invention in any way and the front panel 20 may include more or less icons and LEDs and may employ other LED colors and graphic icons, or with icons that do not include graphic forms of objects but rather include digits, letters, geometrical shapes, etc., and can be associated with specific objects according to the SEs first type 10a on the network.

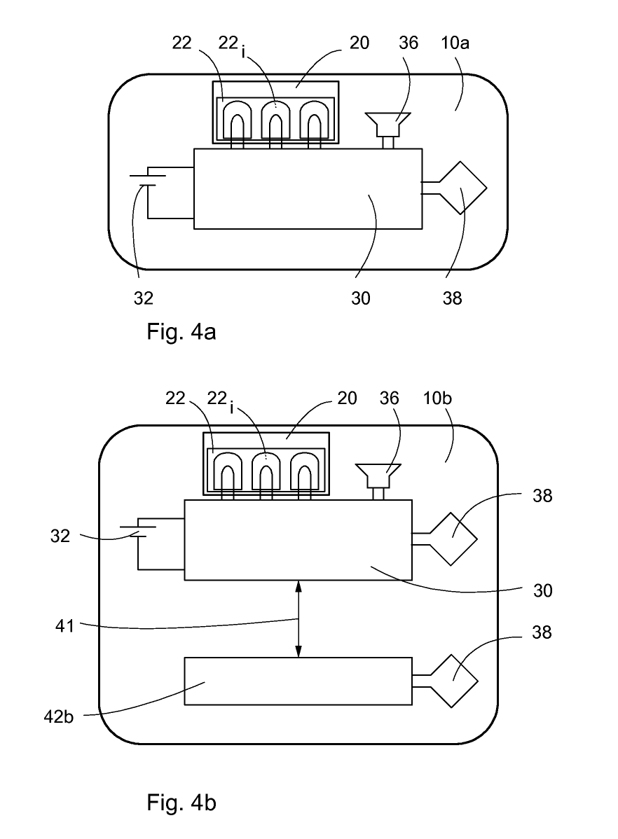

FIG. 4a is a schematic illustration of an exemplary, embodiment of a system element (SE) first type 10a, according to the present invention.

A SE first type 10a includes a SE transceiver and microprocessor unit 30, a SE battery 32, LEDs array 22, a SE speaker 36, and a SE antenna 38.

The LEDs array 22 can include a predetermined number of LEDs 22ₖ, which can be arranged in one line, as shown in FIG. 3.

The SE battery 32 supplies the power to the SE transceiver and microprocessor unit 30 which communicates via the SE antenna 38 with other SEs first type 10a and controls the LEDs array 22 and the SE speaker 36.

FIG. 4b is a schematic illustration of an exemplary, embodiment of a system element second type (SE) 10b, according to the present invention.

The system element second type 10b includes all of the elements included in the SE first type 10a, as well as a transceiver second type 40b.

The transceiver second type 40b enables communicating also with a mobile communication device (MCD), 11 (not shown in the present drawing), which cannot communicate by means of two ways wireless communication first type 12a.

The transceiver second type 40b enables communication by means of wireless communication second type 12b protocols, such as Bluetooth and Wifi, and other communication channels.

The transceiver second type 40b is connected to the SE transceiver and to the microprocessor unit 30 by communication, power and control lines 41.

The transceiver second type 40b transmits and receives by means of an SE antenna 38 connected to it directly, as shown in the present illustration.

In another possible configuration, both types of transmitting and receiving are done by means of only one antenna.

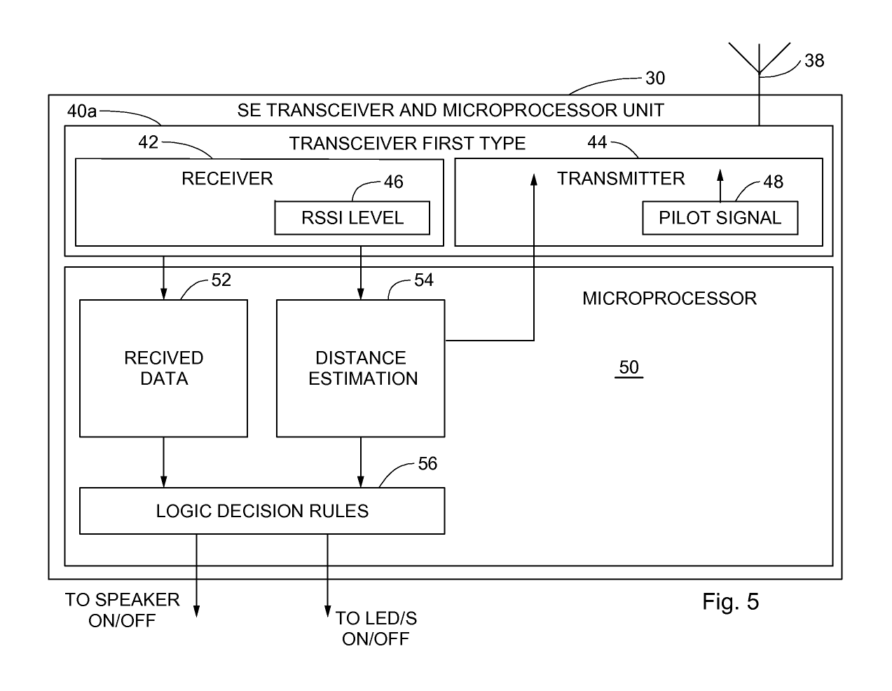

FIG. 5 is a schematic block diagram of a SE transceiver and microprocessor unit 30, according to the present invention.

The SE transceiver and microprocessor unit 30 contains two main blocks: a transceiver first type 40a and a microprocessor 50.

The SE transceiver and microprocessor unit 30 may be implemented as a system on chip.

Communication signals are received using the SE antenna 38 and go to a receiver 42 contained in the transceiver first type 40a, which calculates the received signal strength indication (RSSI) level in a received signal strength indication (RSSI) level block 46. The receiver outputs the received data and RSSI level to the microprocessor 50. Within the microprocessor 50 a received data block 52 stores the received data from the receiver (this data contains distance level that was calculate at other SEs 10) 42 and a distance estimation block 54 stores the RSSI level and estimates the distance from the other SEs first type 10a (not shown in the present figure, shown in FIG. 1) accordingly. The received data and distance estimation are input to a logic decision rules block 56 which is used to decide whether the SE first type 10a is within a specified distance from other SEs first type 10a and if not, signals the SE speaker 36 to sound an audible alert and the SE LEDs 34 to light the appropriate SE LED 34.

The distance estimation generated by the distance estimation block 54 is also inputted to a transmitter 44, which is contained in the transceiver first type 40a and using a pilot signal 48 the distance estimation is transmitted to other SEs 10 via the SE antenna 38.

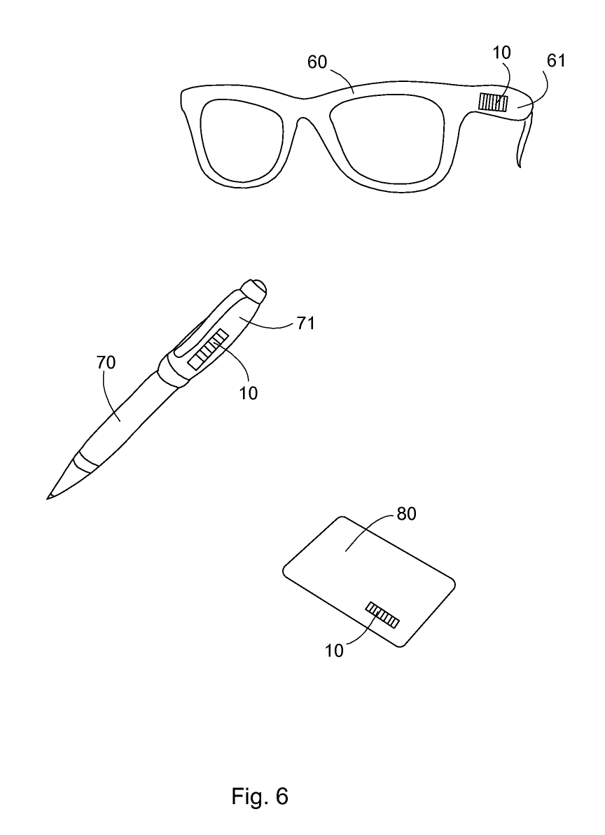

FIG. 6 is a schematic illustration of valuable items equipped with a system element (SE) 10, according to the present illustration.

Examples for valuable items equipped with a SE first type 10a are sun glasses 60 where the SE first type 10a may be embedded within a sun glasses arm 61, a pen 70 with the SE 10 embedded within a pen cap 71 and a credit card sized SE 80.

The above valuable items are exemplary only and are not intended to limit the present invention as the SE first type 10a may be added to many other valuable items.

While the invention has been described with respect to a limited number of embodiments, it will be appreciated that many variations, modifications and other applications of the invention may be made.

What is claimed is:

1. A micro handheld alarm network system comprising:
(a) at least one system element first type, wherein each of said at least one system element first type includes:
(i) a system element transceiver and microprocessor unit:
(ii) a system element battery operatively connected to said system element transceiver and microprocessor unit;
(iii) an system element antenna operatively connected to said system element transceiver and microprocessor unit;
(iv) a system element speaker operatively connected to said system element transceiver and microprocessor unit; and
(v) a system element front panel having a system element front panel surface, operatively connected to said system element transceiver and microprocessor unit,
wherein each of said at least one system elements are operatively connected to any of the rest of said at least two system elements by means of two ways wireless communication.

2. The micro handheld alarm network system of claim 1 wherein each of said system element transceiver and microprocessor unit includes:
a system element transceiver and microprocessor unit, said system element transceiver and microprocessor unit includes:
a microprocessor; and
a transceiver first type, operatively connected to said microprocessor.

3. The micro handheld alarm network system of claim 2, wherein said microprocessor includes:
a received data block for receiving data from said transceiver;
a distance estimation block for receiving data from said transceiver; and,
a logic decision rules block for receiving data from said received data block and from said distance estimation block,
and wherein said transceiver first type includes:
a system element antenna;
a receiver operatively connected to said system element antenna; and
a transmitter operatively connected to said system element antenna.

4. The micro handheld alarm network system of claim 3, wherein said transceiver first type is a system chip.

5. The micro handheld alarm network system of claim 3, wherein said transceiver first type is a Zigbee transceiver.

6. The micro handheld alarm network system of claim 1 wherein each of said system element front panel includes:
(i) a light emitting diodes array, wherein said light emitting diodes array includes at least two light emitting diodes, wherein said at least two light emitting diodes are attached to said system element front panel surface.

7. The micro handheld alarm network system of claim 5 wherein each of said system element front panel includes:
(i) a light emitting diodes array, wherein said light emitting diodes array includes at least two light emitting diodes, wherein said at least two light emitting diodes are attached to said system element front panel surface.

8. The micro handheld alarm network system of claim 6 wherein each of said system element front panel includes further includes:
(ii) at least two icons attached to said system element front panel surface.

9. The micro handheld alarm network system of claim 7 wherein each of said system element front panel includes further includes:
(ii) at least two icons attached to said system element front panel surface.

10. The micro handheld alarm network system of claim 1 wherein said transceiver and microprocessor unit is a system on a chip.

11. The micro handheld alarm network system of claim 9 further comprising:
(b) at least another system element first type, operatively connected to at least one of said system element first type by means of two ways wireless communication first type.

12. The micro handheld alarm network system of claim 9, further comprising:
(b) at least one system element second type, wherein said system element second type includes:
(i) a system element transceiver and microprocessor unit:
(ii) a system element battery operatively connected to said system element transceiver and microprocessor unit;
(iii) an system element antenna operatively connected to said system element transceiver and microprocessor unit;
(iv) a system element speaker operatively connected to said system element transceiver and microprocessor unit;
(v) a system element front panel having a system element front panel surface, operatively connected to said system element transceiver and microprocessor unit; and
(vi) a transceiver second type operatively connected to said system element transceiver and microprocessor unit,
wherein said system element second type is operatively connected to any of the rest of said at least one system element first type by means of two ways wireless communication first type.

13. The micro handheld alarm network system of claim 1 further comprising:
(b) a mobile computing device, operatively connected to at least one of said system element first type.

14. The micro handheld alarm network system of claim 12 further comprising:
(b) a mobile computing device, wherein said system element second type is operatively connected to said mobile communication device by means of two-way wireless communication, selected from a group consisting of a means of two-way wireless communication first type and a means of two-way wireless communication second type.

15. The micro handheld alarm network system of claim 13 wherein said mobile computing device is a mobile cellular telephone.

16. The micro handheld alarm network system of claim 13 wherein said mobile computing device is a personal media player.

17. The micro handheld alarm network system of claim 16 wherein said mobile computing device is a mobile cellular telephone.

18. The micro handheld alarm network system of claim 16 wherein said mobile computing device is a personal media player.

19. A method for alerting to a loss of any network entity comprising:
(a) receiving communication signals from an element of a micro handheld alarm network system;
(b) calculating received signal strength indication (RSSI), of said communication signals;
(c) outputting received signal data and RSSI to a microprocessor;
(d) storing said received data and said RSSI;
(e) estimating distances from other system elements, of said micro handheld alarm network system;
(f) deciding whether distance from said other system elements is within a specified distance;
(g) sounding an alert and lighting LEDs if needed; and
(h) sending estimated distances to said other system elements, of said micro handheld alarm network system.
